(19) United States
(12) Patent Application Publication
(10) Pub. No.: US 2004/0044619 A1
(43) Pub. Date: Mar. 4, 2004

(54) Method and apparatus for credit card inquiry using cable network

(76) Inventor: Jung-Yong Chung, Seoul (KR)

Correspondence Address: VENABLE, BAETJER, HOWARD AND CIVILETTI, LLP, P.O. BOX 34385, WASHINGTON, DC, 20043-9998, US

(21) Appl. No.: 10/450,686

(22) PCT Filed: Dec. 31, 2001
(86) PCT No.: PCT/KR01/02315

(30) Foreign Application Priority Data
Dec. 30, 2000 (KR) 20000087541

(51) Int. Cl. G06F 17/60

(52) U.S. Cl. 705/39

(57) ABSTRACT

A method and apparatus for a credit card inquiry using a high-speed cable network is disclosed. The apparatus for a credit card includes: a communication unit for transmitting/receiving data necessary for a credit card inquiry to/from a master modem in a high speed communication network; a connection unit for connecting to another credit card inquiry system; a first controlling unit for processing information from the communication unit and the connection unit; a first storing unit for storing programs and information related to the first controlling unit; an output unit for outputting the information from the first control unit; a reading unit for reading information in the credit card; a key input unit for receiving a value necessary for approving a credit dealing; a PSTN communication unit for performing a communication through a public switched telecommunication network; a second controlling unit for controlling the output unit, the card reading unit, the key input unit; and a second storing unit for storing programs and information related to the second controlling unit.

### TECHNICAL FIELD

The present invention relates to a signal conversion apparatus for credit card inquiry and a credit card inquiry method using the signal conversion apparatus and a high-speed apparatus for credit card inquiry using the credit card inquiry method and a credit card inquiry method using the high-speed apparatus for credit card inquiry; and, more particularly, to a signal conversion apparatus for credit card inquiry and a credit card inquiry method using the signal conversion apparatus and a high-speed apparatus for credit card inquiry using the credit card inquiry method and a credit card inquiry method using the high-speed apparatus for credit card inquiry that can cut off card inquiry time and communication cost drastically by attaching a separate signal conversion apparatus and using it without any change in a credit card inquiry device or using a credit card inquiry device to which the signal conversion apparatus is inserted directly, and performing credit card inquiry through a cable TV network.

### BACKGROUND ARTS

FIG. 1 is a diagram showing a conventional credit card inquiry system using a telephone network and a packet network. When a customer wants to pay his bill with his credit card at a card affiliated store for goods or service, the affiliated store collects user information registered in the credit card, transaction information generated from the credit card inquiry device 11 installed in the store and information of the affiliated store and then asks for an approval to a credit card company. At this time, usually a general telephone network is used.

That is, the transaction approval request from a credit card inquiry device 11 of an affiliated store is transmitted to a relay system 13 of a value added network (VAN) company through a telephone line or a packet network 12. At this time, since the credit card inquiry device 11 has an apparatus inside to transmit information to a designated relay system 13 of a VAN company only, the credit card approval request is transmitted to the designated relay system 13 of the VAN company.

The relay system 13 of the VAN company which receives the transaction approval request reads credit card company information stored in the user information of the transaction approval request, transmits the details related to the approval request to a transaction approval system of a corresponding card company and thereby the approval is made. Here, the communication line mostly used between the relay system 13 of the VAN company and the transaction approval system 15 of the corresponding card company is dedicated line network 14.

The transaction approval system 15 of the credit card company, which receives the transaction approval request, compares the transaction approval request details including user information, transaction information and affiliated store information with credit card holder information and affiliated store information registered at the credit card company for detecting any reason of disqualification of both the customer 10 and the affiliated store of credit card inquiry device 11 and verifying the transaction made between the customer 10 and the affiliated store after detecting and verifying, the transaction approval system 15 of the credit card company sends out the result for the transaction approval request to the relay system 13 of the VAN company.

After receiving the result, the relay system 13 of the VAN company analyses the affiliated store information included in the transaction approval result and sends it back to the credit card inquiry device 11 of the affiliated store. After receiving the transaction approval result, the credit card inquiry device 11 of the store passes the result of the payment to the customer 10. By passing the result to the customer 10, a credit card approval process is completed.

In case that analogue telephone network is used, for the credit card approval process, it gives inconvenience to the users due to long call access time and long service time (especially in a case of making calls to out of town). Also a low call access rate of the analogue telephone network causes repetition of the credit card approval process. This is a fundamental problem that cannot be solved with technical advances. In case of an affiliated store using a general public switched telephone network (PSTN), it takes 6-8 seconds for a switching device of a telephone office to set up a call to a MUX of a VAN company. Communication for credit card inquiry is performed afterwards, the average card inquiry time reaches about 10-20 seconds. Also, using a dial modem, there is a problem of frequent disconnection.

Meanwhile, a packet network can be used instead of the analogue telephone network, for example, a Hinet-P of Korea Telecom or a DNS network of DACOM. The method shortens call access time to some extent, but generally, the service of the packet network is provided only in certain limited place such as big cities and the service charge is expensive so it is hard to use this method generally except big affiliated stores.

Further, as for affiliated stores, this method causes inconvenient to customers by making them wait as long as 10-20 seconds, which is an average time taken for one-time card inquiry. The stores cannot use a telephone during the credit card approval process, and there is another inconvenience that a separate telephone should be set up along with the credit card inquiry device for a receiving/transmitting phone call and the stores should pay phone charge doubly.

Also, since the affiliated stores access to the credit card company through the VAN company by using a telephone line, they should pay for the communication cost as much as 40 Won per the inquiry.

Also, since only one communication line is provided to the conventional card inquiry system, it becomes impossible to inquire credit cards whenever there is network error, causing much inconvenience to customers.

Also, using a PSTN network, the conventional card inquiry system cannot be provided with high-speed data communication service, e.g., Internet, voice of Internet protocol (VoIP), video on demand (VOD), etc., and technically, it is impossible to provide various additional services through credit card inquiry devices because every card inquiry device should be ported one by one when there is change in software.

### DISCLOSURE OF THE INVENTION

It is, therefore, an object of the present invention to provide a signal conversion apparatus for credit card inquiry and a credit card inquiry method using the signal conversion apparatus and a high-speed apparatus for credit card inquiry using the credit card inquiry method and a credit card inquiry method using the high-speed apparatus for credit card inquiry that uses a separate signal conversion apparatus without any change in a credit card inquiry device by attaching it thereto, or uses a credit card inquiry device with the signal conversion apparatus inserted therein, and performs credit card inquiry through a cable TV network.

In accordance with an aspect of the present invention, there is provided a credit card inquiry apparatus, including: a high-speed data communication unit for transmitting/receiving data related to credit card inquiry with a master modem set up in a high-speed data communication network; an access unit for accessing to another credit card inquiry apparatus; a first control unit for processing data on communication conducted by the high-speed data communication unit and the access unit; a first storage unit for storing programs and data related to the first control unit; an output unit for outputting the data processed in the first control unit outside; a card reading unit for reading the credit card; a key input unit for inputting a predetermined value needed for a credit card approval; a telephone access communication unit for communicating through a telephone network access; a second control unit for controlling the output unit, the card reading unit, the key input unit and the telephone access communication unit; and a second storage unit for storing programs and data related to the second control unit.

In accordance with another aspect of the present invention, there is provided an apparatus for converting signal applied to a credit card inquiry apparatus, including: a high-speed data communication unit for transmitting/receiving data related to the credit card inquiry with a master modem set up in the high-speed data communication network; an access unit for accessing to another credit card inquiry apparatus; a control unit for processing data on communication performed by the high-speed data communication unit and the access unit; and a storage unit for storing programs and data related to the control unit.

In accordance with further another aspect of the present invention, there is provided a method for inquiring a credit card applied to a credit card inquiry apparatus, including the steps of: a) recognizing a credit inquiry data signal by reading the credit card of a user and transmitting the recognized credit inquiry data signal into a signal conversion unit; b) at the signal conversion unit, receiving the credit inquiry data signal, modulating the credit inquiry data signal to generate a modulated credit inquiry data signal and transmitting the modulated credit inquiry data signal to a master modem of a CATV broadcasting station through the CATV network; c) at the master modem of a CATV broadcasting station, demodulating the modulated credit inquiry data signal and transmitting the credit inquiry data signal whose protocol is changed to a VAN company; and d) at the VAN company, receiving the protocol-changed credit card inquiry data and requesting credit card inquiry to the credit card company of the customer by using the data of the received credit inquiry data signal.

In accordance with further another aspect of the present invention, the method for inquiring a credit card applied to a credit card inquiry apparatus further includes the step of: e) if the credit inquiry data signal received by the signal conversion unit is a telephone call, transmitting the credit inquiry data signal to the VAN company through the telephone line.

In accordance with further another aspect of the present invention, the method for inquiring a credit card applied to a credit card inquiry apparatus further includes the steps of: f) at the VAN company, receiving the credit inquiry data signal on the user's credit card from the credit card company, transmitting the credit inquiry result signal to the master modem of the cable TV broadcasting station; g) at the master modem of the cable TV broadcasting station, modulating the credit inquiry result signal to generate a modulated credit inquiry result signal and transmitting it to the signal conversion unit of the card affiliated store through the CATV network; and h) recognizing the modulated credit inquiry result signal transmitted through the signal conversion unit and outputting the recognized credit inquiry result.

In accordance with further another aspect of the present invention, there is provided a computer readable recording medium storing instructions for executing a method for inquiring a credit card applied to a credit card inquiry apparatus, the method including the steps of: a) recognizing a credit inquiry data signal by reading the credit card of a user and transmitting the recognized credit inquiry data signal into a signal conversion unit; b) at the signal conversion unit, receiving the credit inquiry data signal, modulating the credit inquiry data signal to generate a modulated credit inquiry data signal and transmitting the modulated credit inquiry data signal to a master modem of a CATV broadcasting station through the CATV network; c) at the master modem of a CATV broadcasting station, demodulating the modulated credit inquiry data signal and transmitting the credit inquiry data signal whose protocol is changed to a VAN company; and d) at the VAN company, receiving the protocol-changed credit card inquiry data and requesting credit card inquiry to the credit card company of the customer by using the data of the received credit inquiry data signal.

In accordance with further another aspect of the present invention, the method for inquiring a credit card stored in the computer readable recording medium further includes the step of: e) if the credit inquiry data signal received by the signal conversion unit is a telephone call, transmitting the credit inquiry data signal to the VAN company through the telephone line.

In accordance with further another aspect of the present invention, the method for inquiring a credit card stored in the computer readable recording medium further includes the step of: f) at the VAN company, receiving the credit inquiry data signal on the user's credit card from the credit card company, transmitting the credit inquiry result signal to the master modem of the cable TV broadcasting station; g) at the master modem of the cable TV broadcasting station, modulating the credit inquiry result signal to generate a modulated credit inquiry result signal and transmitting it to the signal conversion unit of the card affiliated store through the CATV network; and h) recognizing the modulated credit inquiry result signal transmitted through the signal conversion unit and outputting the recognized credit inquiry result.

### BRIEF DESCRIPTION OF DRAWINGS

The above and other objects and features of the present invention will become apparent from the following description of the preferred embodiments given in conjunction with the accompanying drawings, in which:

FIG. 1 is a diagram showing a conventional credit card inquiry system using a telephone network and a packet network;

FIG. 2A illustrates an exemplary view of a credit card inquiry system for credit card transaction approval using a cable TV (CATV) network in accordance with an embodiment of the present invention;

FIG. 2B is a diagram representing an overall network of the system for credit card transaction approval using a CATV network in accordance with the present invention;

FIG. 3 represents a high-speed credit card inquiry device in accordance with an embodiment of the present invention;

FIG. 4 is a block diagram describing the function of internal constituents of the high-speed credit card inquiry device in accordance with an embodiment of the present invention;

FIG. 5 is a diagram illustrating the arrangement of major unit of the high-speed credit card inquiry device in accordance with an embodiment of the present invention;

FIG. 6 is a diagram depicting the external structure of a signal conversion apparatus in accordance with an embodiment of the present invention;

FIG. 7 is a block diagram illustrating the internal function of the signal conversion apparatus in accordance with an embodiment of the present invention;

FIG. 8 is a diagram showing the cable connection of the signal conversion apparatus in accordance with the present invention;

FIG. 9 is a diagram depicting software frame of the high-speed credit card inquiry device in accordance with an embodiment of the present invention;

FIGS. 10A to 10D are diagrams illustrating communication process between internal processors of the high-speed credit card inquiry device in accordance with an embodiment of the present invention;

FIG. 11 is a diagram depicting external structure of a master modem in accordance with an embodiment of the present invention;

FIG. 12 represents a diagram of an affiliated store management system in accordance with an embodiment of the present invention; and

FIGS. 13A and 13B are communication flow chart showing a credit card inquiry method using a cable TV network in accordance with an embodiment of the present invention.

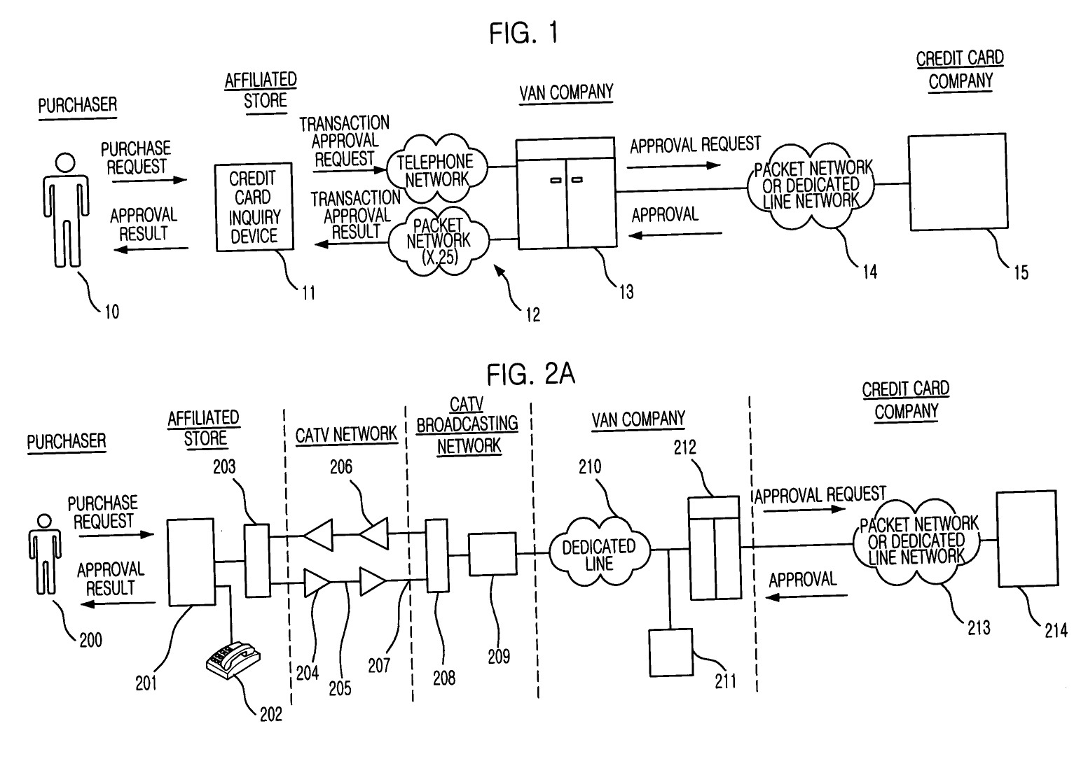

### MODES FOR CARRYING OUT THE INVENTION

Other objects and aspects of the invention will become apparent from the following description of the embodiments with reference to the accompanying drawings, which is set forth hereinafter.

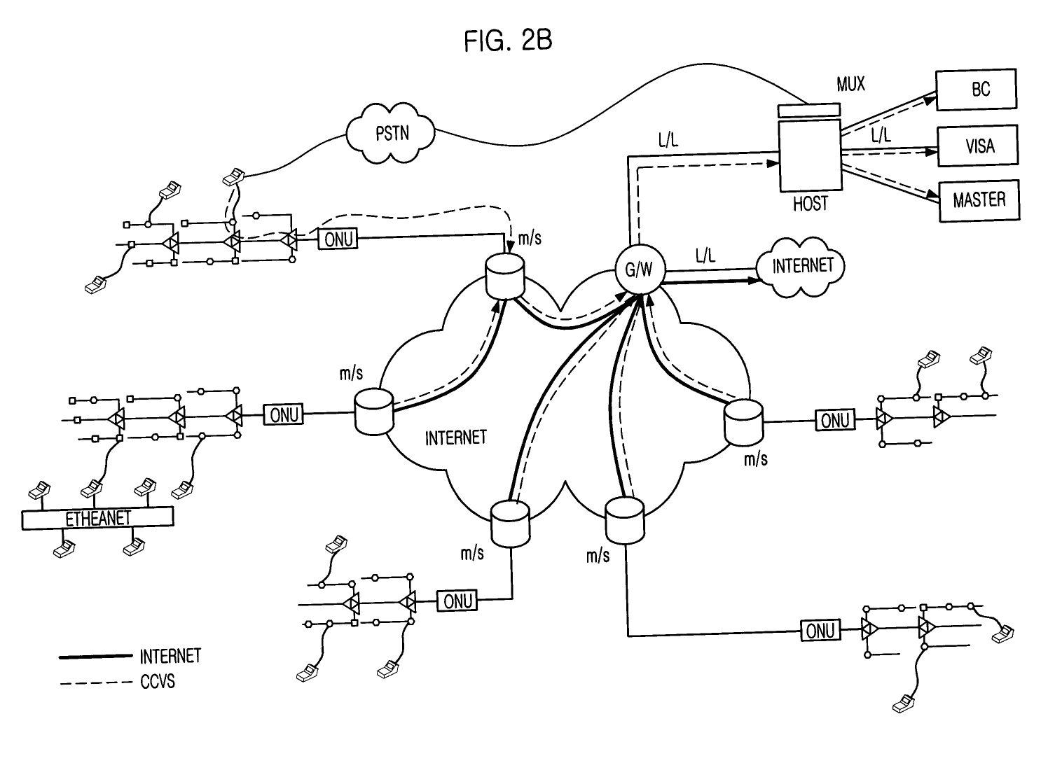

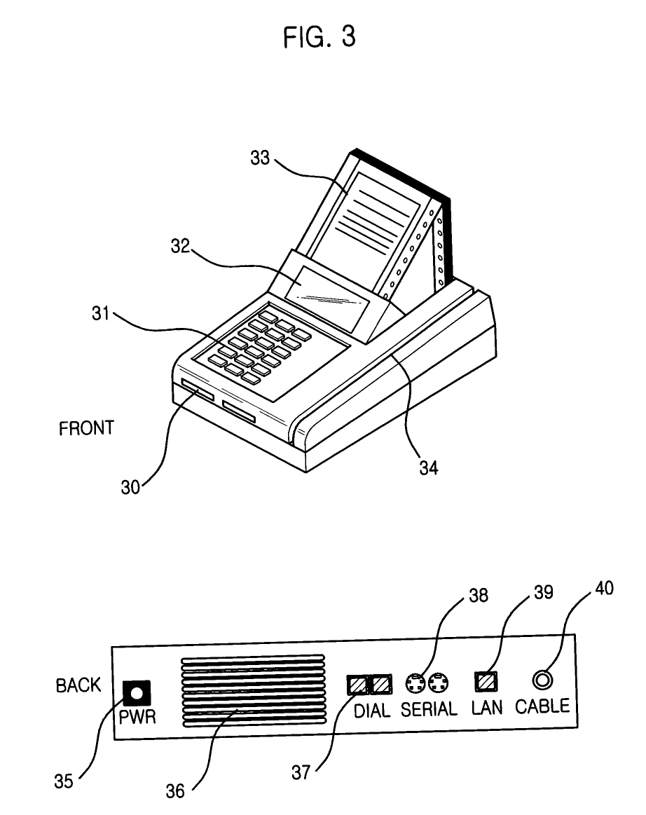

FIG. 2A illustrates an exemplary view of a credit card inquiry system for credit card transaction approval using a CATV network in accordance with the present invention.

As illustrated in FIG. 2A, for a credit card holder's payment request for goods or services, the credit card inquiry device 201 of an affiliated store operates though a telephone line and dedicated line with the same inquiry device as conventional one.

The present invention attaches a signal conversion apparatus 203 to a conventional credit card inquiry device 201 and includes a band separation filter 208 which separates and passes upstream and downstream signals and a master modem 209 which performs intercommunication with the signal conversion apparatus 203 set up in the affiliated store and communicates it with the HOST computer of the VAN company.

Since the management system 211, a terminal for managing the present system, is set up in the VAN company though a dedicated line, it is possible to monitor and manage the normal operation of the signal conversion apparatus 203 in the affiliated store. By the computerized management system 211, it's possible to cope with any mechanical error rapidly and to prevent complaint from the affiliated stores due to the mechanical error in advance.

Meanwhile, although the function for monitoring operation is not added to the credit card inquiry device 201, the communication status between the credit card inquiry device 210 in the affiliated store and the Host 212 of the VAN company can be monitored always, since an additional circuit for sensing error in communication between the two is installed in the signal conversion apparatus 203.

The present invention never stops serving because in case that communication is impossible due to cable TV network error, the system is switched to a telephone line automatically. In other words, this invention adopts double communication line system using the cable TV network as a main and the phone line as a preparatory line in case of error occurring in the main line. That is, normal transaction approval request uses the cable TV network, but in case that error occurs in the cable TV network, communication is carried out through the conventional telephone line.

After fixing the network error, a communication route is reestablished by automatic conducting of the management system 211 in the VAN company. The communication process for a credit card approval is as follows. At first, the approval request is requested by the credit card inquiry device 20 when the customer 200 wants to purchase a good or service. The approval request is passed to the signal conversion apparatus 203 for transmitting the approval request through the cable TV network. And then the approval request is passed through a certain frequency band of an upstream amplifier 204 of the cable TV network. Finally, the approval request is arrived to the master modem 209 through the band separation filter 208 installed at a cable TV broadcasting station.

The master modem 209 passes the cable TV (CATV) network signal to the host 212 of the VAN company though the dedicated line 210. Afterwards, the communication method between the VAN company and the credit card company follows the conventional one.

The approval request signal is transmitted to the host 212 of the VAN company along the dedicated line 213 installed from the credit card company 214 to the VAN company. This signal is transmitted to the signal conversion apparatus 203 set up in the affiliated store by passing through the master modem 209 in the CATV broadcasting station and a particular frequency band of the downstream amplifier 206 of the CATV network. The credit card approval result is also passed to the user and the procedures for card approval are completed.

Reference numeral “205,” “207” of FIG. 2A are high-formed coaxial cables or optical cables. A relay unit is equipped at inside of the signal generator to switch the communication line from the CATV network to the telephone line automatically or manually just in case that error occurs in the CATV network.

FIG. 2B is a diagram representing an overall network of the system for credit card transaction approval using a CATV network from the high-speed credit card inquiry device of the affiliated store to the credit card firm in accordance with the present invention.

Without additional investment, the network company can provide a nation-wide service by using currently established network equipment. Transmission data of a credit card inquiry service is as small as 120 bytes, therefore, the backbone network of the network company is not affected by the credit card inquiry service.

Hereinafter, the additional equipments for embodying the present invention, i.e., the high-speed credit card inquiry device 201 or signal conversion apparatus 203, band separation filter 208, master modem 209 and management system 211, will be described more in detail.

FIG. 3 represents a high-speed credit card inquiry device in accordance with an embodiment of the present invention.

As shown in FIG. 3, the high-speed credit card inquiry device (credit card checking device) of the present invention uses TCCP/IP protocol and with high-speed RF modem, it can provide high-speed data service, which the conventional credit card checking device couldn't.

The front of the product of the present invention includes a body 30 of the credit card inquiry device, a key input board 31 composed of 5×7 rows and columns of Arabic numerals and function keys, a display unit 32 for showing inquiry request details, inquiry result and communication status, a receipt issue unit 33 for printing out the result of the inquiry and a card reader 34 for reading in credit card information.

The power connection unit 35 on the backside is for power connection in AC or DC. In case of using AC, an adapter of 110-220V, and in case of DC, a 6V adapter are used. The power consumption of the present device is under 15W.

The ventilation opening 36 is for emitting out heat generated in the internal circuit element, and the telephone connection unit 37 is made fit in RJ-11 modular jack so that the device could use the conventional telephone line.

Besides, there are serial communication port 38 for accessing to a credit card inquiry device supporting a serial communication, a LAN access port 39 for accessing to a credit card inquiry device supporting a LAN communication and a cable access port 40 for accessing to a CATV network.

As it's possible to access to both serial and LAN communications, the present device is applicable all other apparatus using the same protocol.

The ventilation opening 36 is used to emit out heat generated in the internal circuit element. Being made on the back, sides and the front, it helps air come and go back and forth right and left, thus increasing reliability of the device.

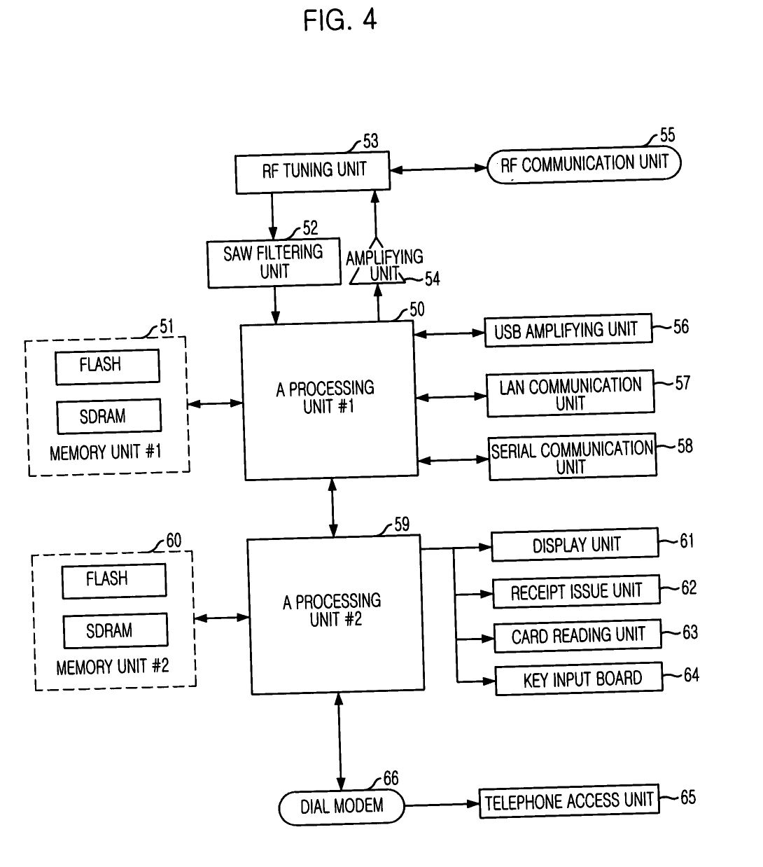

FIG. 4 is a block diagram describing the function of internal constituents of the high-speed credit card inquiry device in accordance with an embodiment of the present invention.

In accordance with the present invention, the high-speed credit card inquiry device is divided into two major parts: high-speed data modem block and dial modem block. Functionally, it is composed of a processing unit #1 50, memory unit #1 51, SAW filtering unit 52, RF tuning unit 53, amplifying unit 54, RF communication unit 55, a Universal Serial Bus (USB) amplifying unit 56, LAN communication unit 57, serial communication unit 58, processing unit #2 59, memory unit #2 60, display unit 61, receipt issue unit 62, card reading unit 63, key input board 64, telephone access unit 65 and dial modem 66.

The processing unit #1 50 minimizes error occurring rate of the present invention by using a mono chip. It employs an 80 Mhz MIPS 32 bit CPU and adopts a QAM/QPSK modulation method for speed up data signal. The processing unit #1 50 plays a pivotal role in the device of present invention and it is in charge of device initialization, I/C control and management of internal operation processor. Also, it reads information through the RF tuning unit 53 and stores the result of the reading in the memory unit #1 51 or controls the LED showing the operation status of the credit card inquiry device.

Also, the processing unit is composed of two processors each in charge of the high-speed data modem block and the dial modem block. The processing unit #1 50 takes charge of all information processing on communication affair conducted with the master modem, while the processing unit #2 59 loads a 16 bit CPU and it receives information from the processing unit #1 50 and outputs the result through the display unit 54 and receipt issue unit 55 or display it on the LCD display, or it passes to the processing unit #1 50 the credit card information read in from the card reading unit 56.

Also, adopting double processors, the present invention tried to minimize the possibility of service malfunction caused by network error. Accordingly, although it has been basically impossible to provide service from the source during network error, the present invention resolves the complaints from affiliated stores by making it possible to provide the service through other line in case of service malfunctioning caused by the network error.

The memory unit 51 uses a 64 KB flash memory containing an operating program and an SDRAM that works as a space for running the program. It mostly performs the function of storing or outputting program and information.

The SAW filtering unit 52 is used to select out a frequency that the credit card inquiry device needs to receive among all the signals in the band of 54˜860 Mhz inputted from the RF tuning unit. It uses an element with fine filtering function.

The PF tuning unit 53 is installed in the input unit of the present invention. The RF tuning unit 53 synchronizes with a frequency of a regular electric signal, extracts the frequency selectively, performs a function for transmitting or receiving high-speed data signals, converts the RF signals into intermediate frequency (IF) and passes it to the processing unit #1 50.

The amplifying unit 54 amplifies signal level in which the modem is trying to transmit when reference signal to noise (SN) ratio for successful communication with the master modem is low. The amplifier can amplify signals on a 1 dB basis. The level of signals is controlled by increasing it step by step based on the SN ratio received from the master modem until it becomes to a normal state according to the level value pre-set in the processing unit #1 50.

The RF communication unit 55 uses a 5C-2V coaxial cable for 75 ohm as a connection terminal to communicate with a CATV network or HFC network. This connection port communicates through the bands of upstream 5-42 MHz or 5-88 MHz and downstream 54˜860 MHz. For the connection terminal, F-type “male” connecter is used.

The USB communication unit 56 is an option, which makes it possible to access to the Internet network by connecting the card inquiry device with a computer.

The LAN communication unit 57 has a 10/100 Base-T interface and because it supports IEEE802.3 standard LAN protocol, access to every device supporting standard LAN protocol is possible. Particularly, in case of a big credit card affiliated store whose card inquiry system is established in a LAN environment, credit card inquiry devices in all counters can be converted into the device of the present invention easily by setting up one master credit card inquiry device and connecting it to those in other counters in LAN. At this time, RJ-45 connecter is used as a connection terminal and the maximum number of card inquiry devices is limited to 16 units. The number of connected card inquiry devices is limited to 16 in order to maintain the bit error rate (BER) less than 10−8.

The serial communication port 58 is composed of two terminals and they are for RS-232C and RS-485 communication. The connection terminals are of “9 pin D-female” connectors. In a big affiliated store whose card inquiry system is built up in a serial communication environment such as RS-485, since the present invention equipped with the serial communication port 58 for being connected to the existing line, the existing card inquiry devices can be replaced easily.

The memory unit #2 60 has 256 KB flash memory containing an operating program and 128 KB RAM for the program-running space. It performs the function of storing and outputting the program and information generated in the dial modem block.

The display unit 61 shows the communication status of the device and the result of credit card inquiry though a 128×64 mm LCD monitor. Mostly, it displays the normal operation status of the communication line, inquiry details including payment amount, the status of approval completion, etc. In particular, in case of CATV network error, it goes off alarm and gives notice so that the user could switch it into the telephone line and use.

The receipt issue unit 62 has a mechanism of a printer that prints out the approval information for the credit card inquiry.

The card reading unit 63 (MCR) is for reading information stored in the magnetic tape of a credit card when the card is swiped.

The key input board 64 is formed of 5×7 rows and columns of Arabic numerals and major function keys. The major function keys include an approval request key, a key for inputting the amount for inquiry, a key for checking checks and a telephone conversion key.

The function of telephone connection block 65 and dial modem 66 are the same as those of conventional credit card inquiry devices.

The major function and size of the high-speed modem block of the present invention are as shown in Table 1.

TABLE 1

| | Item | Specification |
|---|---|---|
| Downstream | Frequency Band | 88 MHz˜860 MHz |
| Property | Modulation Method | 64 QAM/256 QAM |
| | Transmission Speed | Up to 30 Mbps/64 QAM |
| | | UP to 40 Mbps/256 QAM |
| | FEC | Reed Solomon/Trellis |
| | Signal Level | −15 dBmV˜+15 dBmV |
| | Security | DES Decryption |
| Upstream | Frequency Band | 5 MHz˜42 MHz |
| Property | Modulation Method | QPSK/16 QAM |
| | Transmission Speed | Up to 5 Mbps/QPSK |
| | | UP to 10 Mbps/16 QAM |
| | FEC | Reed Solomon |
| | Signal Level | +8 dBmV˜+55 dBmV (16 QAM) |
| | | +8 dBmV˜+58 dBmV (QPSK) |
| Network | MAC Protocol | 10/100 Base-T Ethernet |
| Interface | Network protocol | IP, ICMP, ARP, RARP |
| | Transport Protocol | TCP, UDP |
| | Application | SNMP, TFTP, DHCP, RFC868 |
| | Protocol | |
| | Network Management | MIB-I I, MCNS MIB |
| | Protocol | |
| | Security Protocol | Baseline Privacy, MCNS DES |
| Power | Type | AC/DC Adaptor 6 V |
| | Voltage | AC 100 V˜240 V |

| | |
|---|---|
| Power Consumption | MAC 15 W |
| Operation Temperature | 0° C.˜+70° C. |
| Operation Humidity | 10%˜90% |

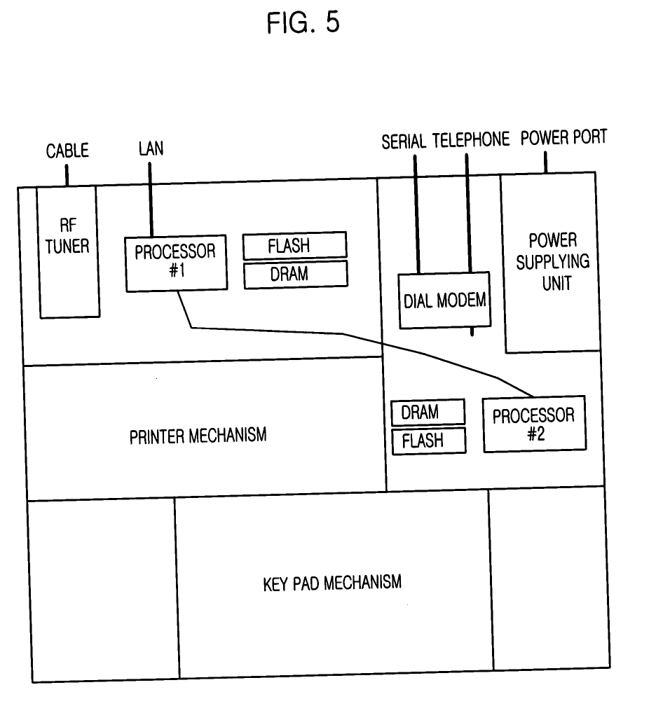

FIG. 5 is a diagram illustrating the arrangement of major unit of the high-speed credit card inquiry device in accordance with an embodiment of the present invention. The high-speed modem and the dial modem are placed in one PCB, and the power supply provides +12V, −12V, +5V, −5V, +3.2V, and −3.2V power they need. Also, for stable power supply, a highly efficient power supply with less heat emission and low power voltage fluctuation rate is employed.

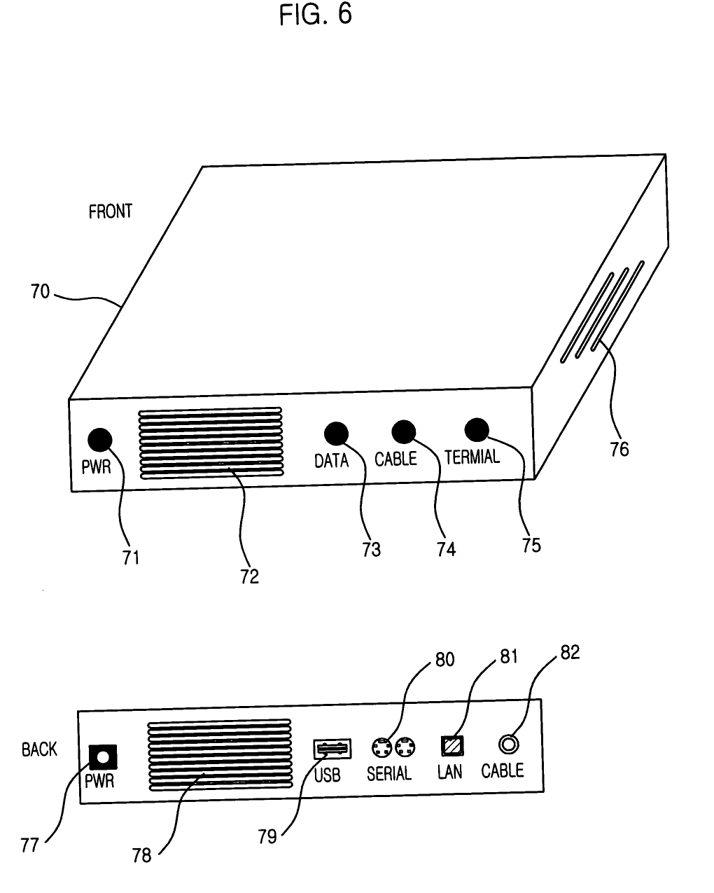

FIG. 6 is a diagram depicting the external structure of a signal conversion apparatus in accordance with an embodiment of the present invention. The drawing shows the exterior view of the signal conversion apparatus, which is a separated device used for connecting to the conventional credit card inquiry device, in accordance with the present invention.

As depicted in FIG. 6, the signal conversion apparatus of the present invention is an external type of the high-speed modem block, which is installed in the high-speed credit card inquiry device. The apparatus is made to be used by being connected to the serial communication port of the conventional credit card inquiry device.

The front view shows a signal conversion apparatus 70, power indicator 71, ventilation openings 72 and 76, data communication indicator 73, cable communication indicator 74 and terminal communication indicator 75. On the backside, there are a power connection unit 77, backside ventilation opening 78, USB communication port 79, serial communication port 80, LAN access port 81 and cable access port 82.

The power indicator 71 on the front side shows the status of power supply of the separated signal conversion apparatus. Under normal operation, it is seen in green, and in case of abnormal condition, it turns red.

The ventilations opening 72 and 76 are for emitting out heat generated from electric part of the circuits by using a high-speed modem. The ventilation openings are positioned on the front, back and both sides.

The data communication indicator 73 shows the status of data communication with the master modem. Under normal operation, it is seen in green, and in case of abnormal condition, it turns red. Whenever communication is under way, the green light is turned on, indicating communication is carried out.

The cable communication indicator 74 shows whether or not communication with the master modem set up in the head end of a broadcasting station or the communication room of the communication company is possible. Under normal operation, it is seen in green, and in case of abnormal condition, it turns red. In case that network error occurs or communication cannot be carried out, it displays “communication error” in the LCD monitor of the credit card inquiry device so that the affiliated store can switch the communication line to the telephone line and continue its work of credit card inquiry.

The terminal communication indicator 75 shows communication status between the conventional credit card inquiry device and the separated credit card inquiry apparatus. Under normal operation, it is seen in green, and in case of abnormal condition, it turns red. Therefore, on the front face, an operation indication block should be formed to check the operating status of the device of the present invention with one look.

The ventilation openings 72 and 76 send out internal heat, and the functions of the power connection unit 77, USB communication port 79, serial communication port 80, LAN access port 81 and cable access port 82 are the same as in FIG. 4.

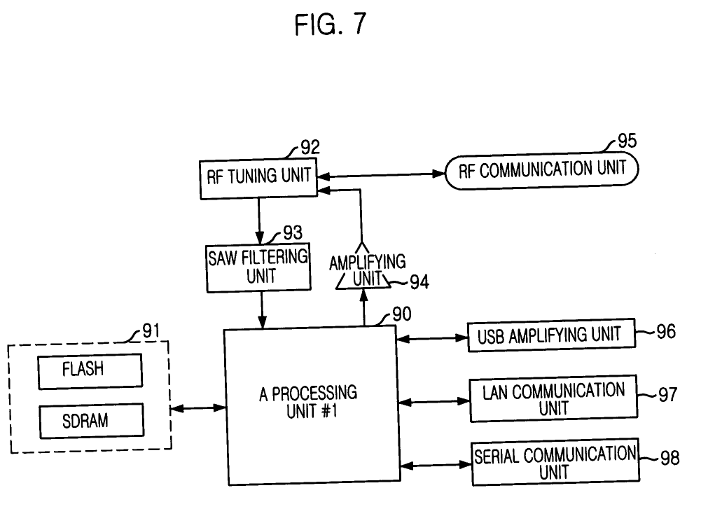

FIG. 7 is a block diagram illustrating the internal function of the signal conversion apparatus in accordance with an embodiment of the present invention.

The internal structure of the device of the present invention includes a processing unit 90, a memory unit 91, a radio frequency (RF) tuning unit 92, a SAW filtering unit 93, an amplifying unit 94, an RF communication unit 95, a USB communication unit 96, a LAN communication unit 97 and a serial communication unit 98. Major functions of them are the same as described in FIG. 4.

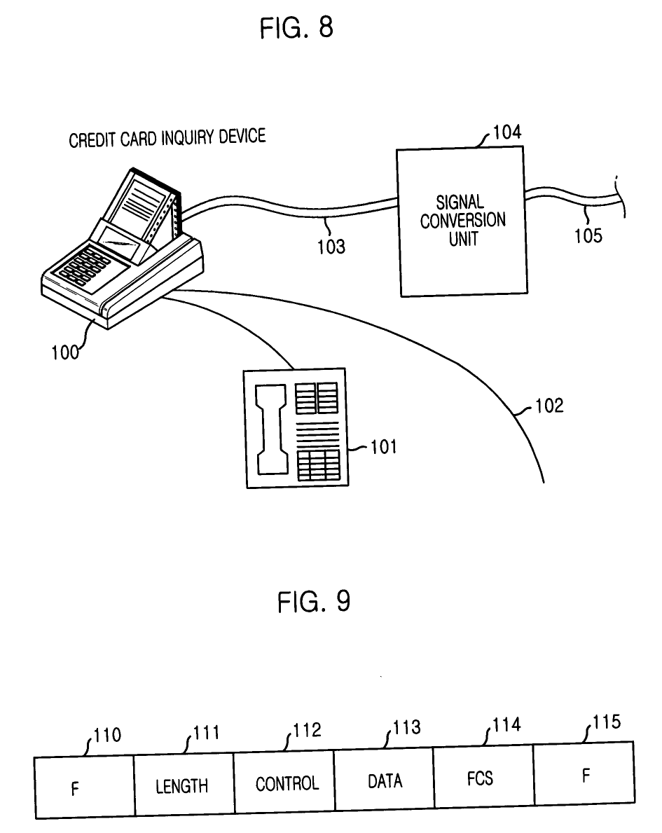

FIG. 8 is a diagram showing the cable connection of the signal conversion apparatus in accordance with the embodiment of the present invention.

The input unit of the signal conversion apparatus 100 is connected 103 through a serial connection to the serial port built in the conventional credit card inquiry device and performs RS-232C communication, while the output unit of it is connected to the CATV line 105. The telephone back-up line 102 is made to use the existing telephone line, eliminating the burden of additional cost.

Accordingly, the affiliated stores are able to receive a stable service by using both the CATV network and the telephone network. Moreover, they can use the telephone 101 simultaneously while inquiring credit cards, which has been impossible with the conventional card inquiry device.

FIG. 9 is a diagram depicting software frame of the high-speed credit card inquiry device in accordance with an embodiment of the present invention.

The interface between the processor #1 and processor #2 is asynchronous serial and the internal communication speed is over 115.2 Kbps. Data transmit/reception uses the method of non parity, 8 data bits and 1 stop bit and signal level is high 5 volt, low 0 volt.

The frame includes a flag sequence field 110, a frame length field 111, a control filed 112, a data field 113, a frame check sequence (FCS) field 114 and flag sequence field 115.

The flag sequence fields 110, 115 are used to synchronize the frame in a bit pattern (01111110; 1 repeats six times) defined in advance to indicate the starting or ending of a frame. It prevents the same pattern as the flag sequence from showing up between the starting flag and the ending flag and they are formed to transmit free bit string in the frame. The length of a flag sequence is 8 bits.

The frame length filed 111 represents a length from the control field 112 to the FCS filed 114. It is composed of 16 bits.

The control filed 112 represents a command for operation specified between the processor #1 and processor #2. 0X01 denotes a request command and 0X02 stands for a data response. Among commands the processor #2 of the control instructs to the processor #1, the transmit value 0X01 of the processor #2 is defined as a connection request and 0X02 is defined as a disconnection request. The reception value of 00X1 denotes a state of connected and 0X02 stands for a state of disconnected, while 0X04 and 0X08(Reserved) mean a data retransmission request.

The data filed 113 contains messages and control information communicated between the two processors. It is composed of up to 512 bytes. The communicated messages include a credit card number, an amount for approval request, an address of the credit card inquiry terminal and in case of a debit card, user's password.

The frame check sequence field 114 is for checking up whether the contents of control and data are transmitted without error and for this procedure, a cyclic redundancy check code method is used.

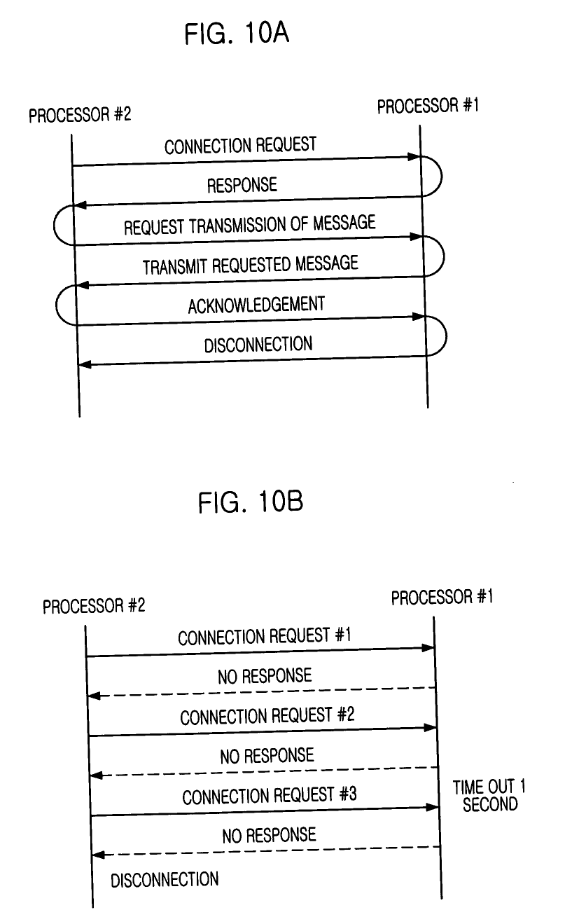

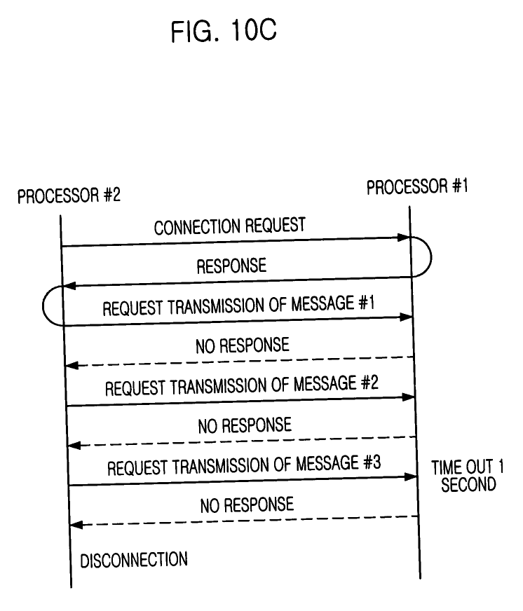

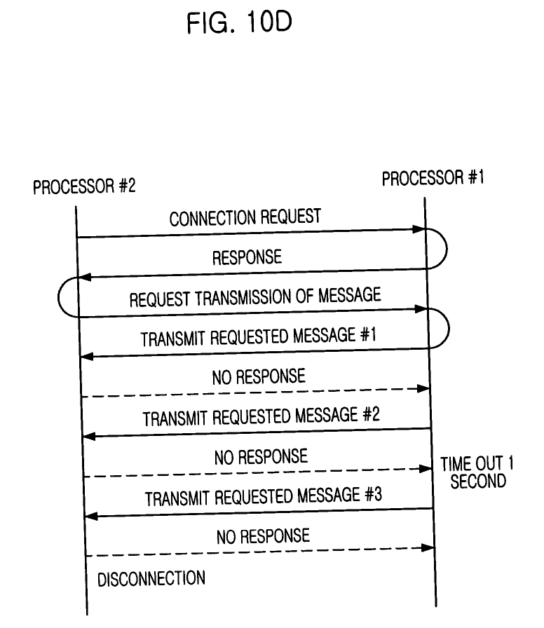

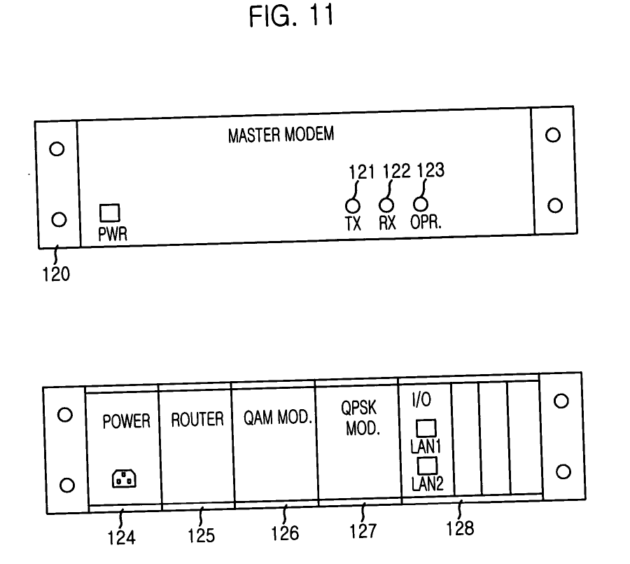

FIGS. 10A to 10D are diagrams illustrating a communication process between internal processors of the high-speed credit card inquiry device in accordance with an embodiment of the present invention.

FIG. 10A show normal communication process when the processor #2 and the processor #1 are in normal condition

FIG. 10B illustrates a communication process protocol in which a connection is treated as ‘Not connected’ when the processor #2 and the processor #1 do not respond to a connection request for initial communication connection three times in a row.

FIG. 10C shows a communication process protocol that disconnects a communication connection in case that there is no response for requesting of sending full information three times in a raw after the connection between the two processors #1 and #2 is confirmed.

FIG. 10D shows an internal communication process that treats as “inability of communication” in case that there is no response of receiving request from a processor #2 after the process #1 requests for sending full information in three times in a raw after the connection between the processor #1 and the processor #2.

In case of network error occurring as seen in FIGS. 10B, 10C and 10D, the present invention notifies the affiliated store by notifying the error on the display monitor or giving an alarm and it is switched to the telephone line automatically so that the user can continue the card inquiry.

FIG. 11 is a diagram depicting external structure of a master modem in accordance with an embodiment of the present invention.

The master modem 120 includes: a routing card 125 for providing a routing function from a data network to an RF cable network; a QAM modulator 126 for processing 64/256 QAM data to transmit upstream/downstream data to the CATV network; a QPSK/QAM modulator 127 for upstream data and a power supply 124.

The routing card 125 provides functions of setting up communication path of the data from the credit card inquiry device in the network and allocating an IP address, modem initialization and environment setup, two 10/100 Base-T Ethernet, etc. Also, as the routing card supports various communication protocols such as IP, TCP, UDP, FTP, TFTP and DHCP that are used in the Internet, it's possible to communicate with a subscriber terminal using the same protocol. The QAM modulator 126 is a signal modulator that modulates data signals into QAM signals and sends it to the downstream cable network. It usually uses 4 MHz IF signals.

The QPSK/QAM modulator 127 is a signal conversion apparatus converting RF signals from the credit card inquiry device to QAM signals. It modulates signals based on the MCNS recommended frame architecture and the MPEG-2 signal protocol.

The I/O card 128 provides one downstream signal port and a plurality of upstream ports. The master modem is loaded with a function to manage the system and the terminal comfortably by using a Telnet from remote places through the simple network management protocol (SNMP).

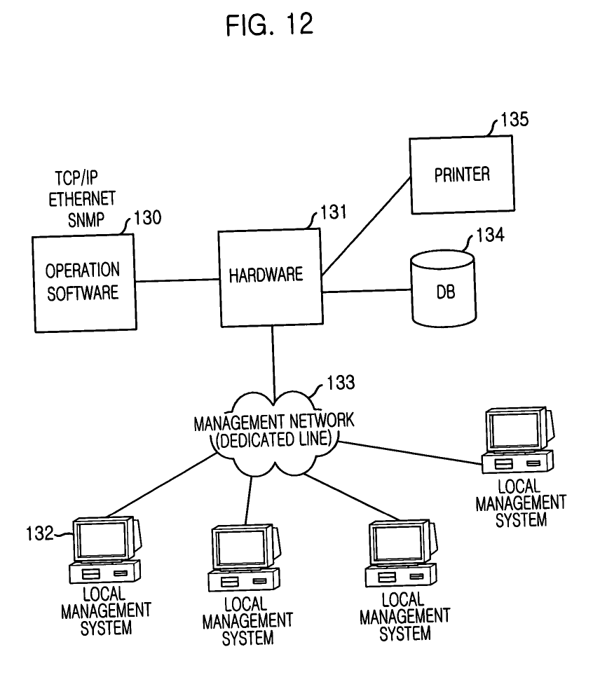

FIG. 12 represents a diagram of an affiliated store management system in accordance with an embodiment of the present invention.

The management system is composed of an operation software 130, hardware 131, output apparatus 135 and local management system 132. By employing the TCP/IP-based SNMP, the management system can be used in the Internet network, too.

However, forming the management network 133 with dedicated lines in consideration of network security problem, the management system can block off invasion from outside in advance, such as hackers.

The management system 131 processes management detail received from the signal conversion apparatus and stores it in a database 84.

The management system 131 is a network management system formed based on such operation system as Windows, NT98, etc. It is divided into two: a single user client for a single user, and a multi user client for a plurality of users. It is possible to access from various places and one user can possibly integrate and manage the entire network.

Also, it provides functions of polling for high-speed credit card inquiry device and signal conversion apparatus, operating a relay switch, setting and recognizing an initial value of downstream signal converter, storing the setting value and adding up to a database, notifying the user of the security and operation status of the signal conversion apparatus (warning, alarm, no response, etc.).

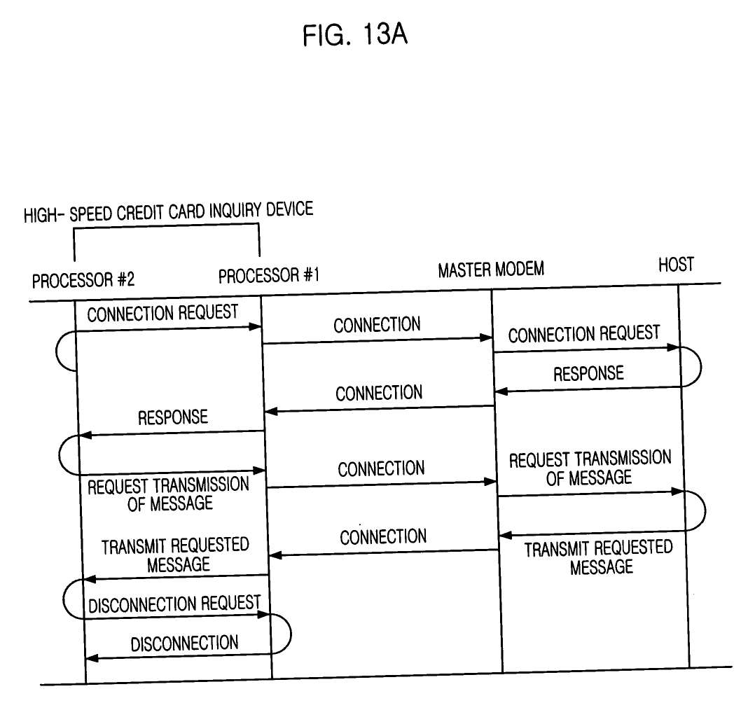

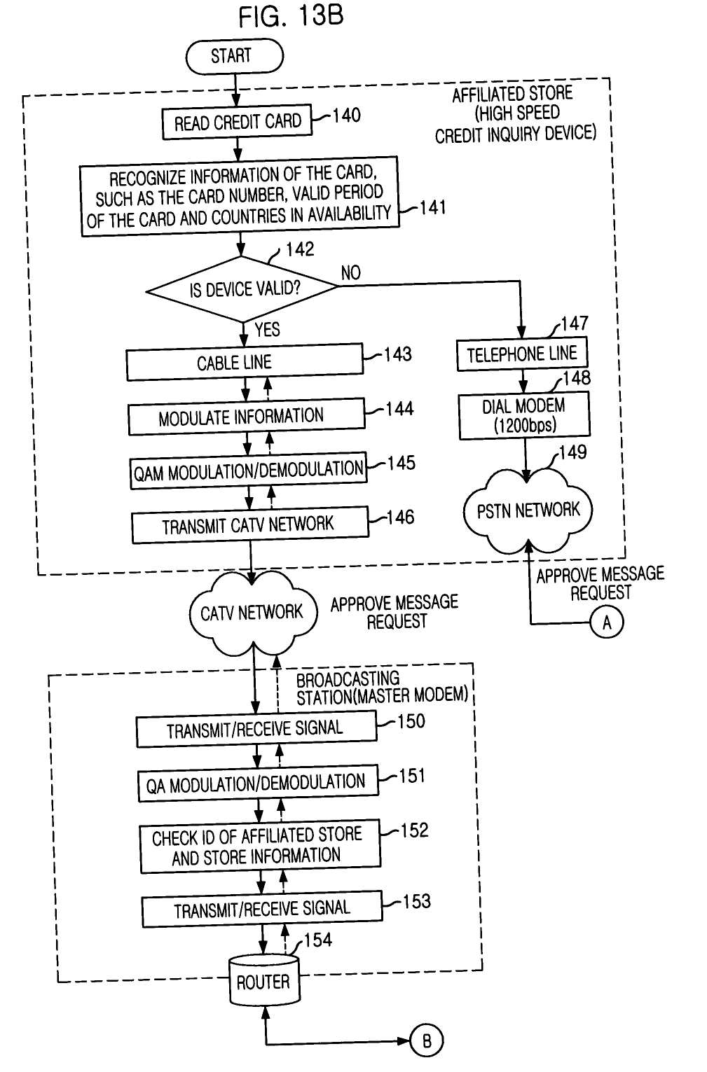

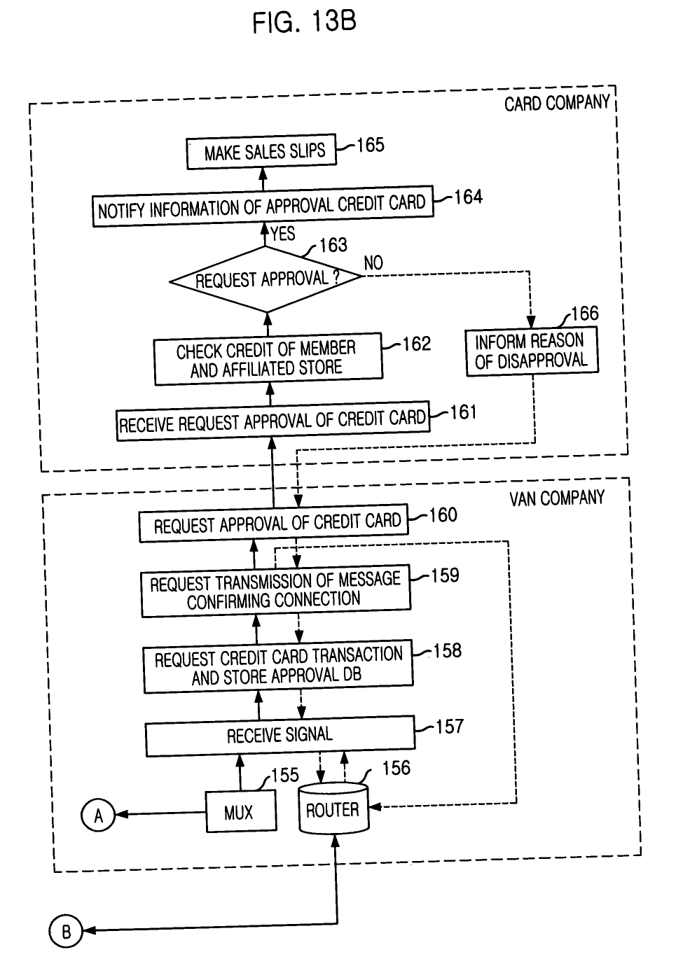

FIGS. 13A and 13B are communication flow charts showing a credit card inquiry method using a cable TV network in accordance with an embodiment of the present invention.

FIG. 13A shows communication flow protocol between the high-speed credit card inquiry device and the host of the VAN company.

Upon the request of the processor #2 of the dial modem unit at inside of the credit card inquiry device, the device is connected to the master modem set up in a broadcasting station or communication center through the processor #1 of the RF communication unit. The master modem determines if the address of the credit card inquiry device is registered and after the check up, the result is transmitted to the host of the VAN company. If the store is a registered affiliated store, the host informs the credit card inquiry device of it. Then, the credit card inquiry device sends the transaction particulars to the VAN company just as it did in the first procedures. Afterwards, the host of the VAN company sends the card information to the host of the credit card company for approval code, which is eventually transmitted to the master modem and the credit card inquiry device. Through these procedures, the credit card approval is completed. The card inquiry system of the present invention secures system reliability since system (master modem, VAN host) error can be blocked off in advance by making the master modem check if the store is a registered affiliated store, which has been possible at the VAN host only in the conventional card inquiry system.

FIG. 13B represents a flow chart depicting credit card inquiry method using a CATV network in accordance with an embodiment of the present invention. The flow chart shows the process that a card affiliated store confirms a credit card holder or availability (possibilities of steal, loss, overdue and limit excess, etc.) of a credit card for a customer's payment, that is, process of credit card approval and inquiry.

First, operation of a credit card inquiry device in an affiliated store will be described.

The credit card inquiry device of an affiliated store reads the card of a user and receives transaction particulars (140). If the device operates normally, it recognizes information of the card, such as the card number, valid period of the card and countries in availability (141) and the information is modulated (144) to a 64 QAM signal (145) through the cable line (143) and then transmitted to the cable network. The signal arrives at a master modem set up in a broadcasting station for the moment.

If the credit card inquiry device is in abnormal state, the information is transmitted to the MUX 155 of the VAN company through the telephone line 147, the 12000 bps dial modem 148 and the PSTN network 149 of Korea Telecom.

Following is the operation of the master modem.

The data signal received (150) in the master modem is modulated (151) to QAM and after going though a checking procedure (152) if the user is a registered member, the signal is transmitted (153) to the router (154) set up in the broadcasting station. At this point, the internal information of the data contains a message for confirming if the store is an affiliated store registered to the corresponding VAN company.

The operation of the VAN host is described hereinafter.

The VAN company confirms (158) if it's an affiliated store of its own based on the data information received (157) through the MUX (155) or router (156), and after confirming that it is, it sends out detail transmission request (159) on the actual transaction particulars to the high-speed credit card inquiry device.

The high-speed credit card inquiry device set up in the affiliated store requests to the VAN host for approval on such transaction details as the affiliation number of the store, terminal password, date, time and amount of transaction, currency sign, installment months, etc. The host of the VAN company stores the information in its database (158) and transmits (160) it to the credit card company such as BC, Master, etc., through the dedicated line. In short, the VAN company transmits card approval request signal to the corresponding credit card company based on the subscriber information.

Meanwhile, the credit card company performs identity inquiry procedures (162) for the subscriber and affiliated store based on the signal received from the VAN company, and notifies (164) them of the credit card approval in response to the approval request (163). If there is any ground against approval, the disapproval result (166) is transmitted to the VAN company. The VAN company transmits it to the master modem and the master modem passes the result of credit card disapproval to the high-speed credit card inquiry device or signal conversion apparatus. When the card approval procedures are completed, the credit card company draws up (165) a sales slip for the approval/inquiry of the corresponding credit card

As described above, the method of the present invention can be embodied into a program and stored in a computer-readable recording medium such as CD-ROMs, RAMs, ROMs, floppy disks, hard disks, optical magnetic disks, etc.

By supporting high communication speed from 1,000 times up to 8,300 times by providing a speed of more than 10 Mbps in full-duplex, which has been 1,200 bps in the existing telephone network or less than 9.6 Kbps in a Hinet-P network, the present invention shortens credit card inquiry time remarkably as well as cutting off communication cost considerably.

Also, even for an affiliated stores set up with a convention credit card inquiry device, high-speed credit card inquiry is possible just by equipping a signal conversion apparatus with an additional advantage of saving communication cost dramatically.

For example, since this invention uses a CATV network, users can use the network at 3,475 Won per month (official price announced by the Ministry of Information and Communication). In case of using an Internet network, e.g., “HanaFOS”, “Thrunet”, etc., users can use the Internet network at as inexpensive as around 10,000 Won per month. Therefore, the affiliated stores can use the CATV network at a fixed charge as much as basic telephone cost, which brings about over 70% cost saving, and in case of using the Internet network, more than 50% cost saving effect (Currently, telephone service charge paid by an affiliated store with conventional card inquiry device reaches about 20,000 Won per month.). Under the circumstances that the rate of using credit cards goes over 70% and Korea Telecom is getting rid of low-speed dedicated lines, the burden on affiliated stores gets heavier on and on because they have to use common dedicated lines which is far more expensive than current Hinet-P lines.

Also, unlike conventional credit card inquiry system that cannot inquire credit cards during network error, the present invention can provide stable service continuously even in a sudden network error because it adopts double network system.

In short, for the sake of credit card affiliated stores, this invention can save communication charges drastically and reduce delayed time and disconnection state by using stable exclusive network. For the sake of network operating company owning CATV network, it can create new earnings with the existing cable network used for Internet only by accommodating an additional service thereto. For VAN company, the present invention can earn more service charges from the credit card company due to increasing number of affiliated stores and make more profit from lowered communication cost and increase of affiliated stores, from which the drop in service fee is expected. The present invention can activate VAN market since all of the credit card holders, affiliated stores, CATV network business, VAN company and credit card company can benefit from the present invention.

Since the CATV network uses a coaxial/optical cable which is locally closed, the present invention has a high security and stability compared to a credit card inquiry system served through public Internet.

Also, the present invention provides an infrastructure by providing various data communication services besides credit card inquiry.

While the present invention has been described with respect to certain preferred embodiments, it will be apparent to those skilled in the art that various changes and modifications may be made without departing from the scope of the invention as defined in the following claims.

1. A credit card inquiry apparatus, comprising:
a high-speed data communication means for transmitting/receiving data related to credit card inquiry with a master modem set up in a high-speed data communication network;
an access means for accessing to another credit card inquiry apparatus;
a first control means for processing data on communication conducted by the high-speed data communication means and the access means;
a first storage means for storing programs and data related to the first control means;
an output means for outputting the data processed in the first control means outside;
a card reading means for reading the credit card;
a key input means for inputting a predetermined value needed for a credit card approval;
a telephone access communication means for communicating through a telephone network access;
a second control means for controlling the output means, the card reading means, the key input means and the telephone access communication means; and
a second storage means for storing programs and data related to the second control means.

2. The apparatus as recited in claim 1, wherein the master modem is set up in the cable TV broadcasting station and a hybrid fiber coax (HFC) network center of an infra communication company.

3. The apparatus as recited in claim 1, wherein the high-speed data communication means includes: a radio frequency (RF) tuning unit, an RF communication unit, a saw filter and an amplifier.

4. The apparatus as recited in claim 1, wherein the access means includes a Universal Serial Bus (USB) communication unit, a local area network (LAN) communication unit and a serial communication unit.

5. The apparatus as recited in claim 1, wherein the first control means processes data on the interface in need of high-speed communication, serial communication, USB communication and LAN communication between the credit card inquiry apparatus and the master modem.

6. The apparatus as recited in claim 1, wherein the output means includes a display unit and a receipt issue unit.

7. The apparatus as recited in claim 1, wherein the key input means is for approval request, input of an amount to inquire, menu selection and option selection.

8. The apparatus as recited in claim 1, wherein the second control means processes related data generated by the telephone access communication means, stores inquiry result and processes data on the input/output and display.

9. The apparatus as recited in any one of claims 1 to 8, wherein the high-speed data communication means and the low-speed telephone access communication means are separated in the credit card inquiry apparatus so that communication could be still possible by switching the network to each other in case of network error and the telephone could be used simultaneously during the inquiry.

10. An apparatus for converting signal applied to a credit card inquiry apparatus, comprising:
a high-speed data communication means for transmitting/receiving data related to the credit card inquiry with a master modem set up in the high-speed data communication network;
an access means for accessing to another credit card inquiry apparatus;
a control means for processing data on communication performed by the high-speed data communication means and the access means; and
a storage means for storing programs and data related to the control means.

11. The apparatus as recited in claim 10, wherein the master modem is set up in a cable TV broadcasting station and a hybrid fiber coax (HFC) network center of an infra communication company.

12. The apparatus as recited in claim 10, wherein the high-speed data communication means includes: a radio frequency (RF) tuning unit, an RF communication unit, a saw filter and an amplifier.

13. The apparatus as recited in claim 10, wherein the access means includes a Universal Serial Bus (USB) communication unit, a Local Area Network (LAN) communication unit and a serial communication unit.

14. The apparatus as recited in claim 10, wherein the control means processes data on the interface of the credit card inquiry apparatus in need of high-speed communication, serial communication, USB communication and LAN communication with the master modem.

15. The apparatus as recited in any one of claims 10 to 14, wherein the high-speed data communication means and the low-speed telephone access communication means are separated in the credit card inquiry apparatus so that communication could be still possible by switching the network to each other in case of network error and the telephone could be used simultaneously during the inquiry.

16. A method for inquiring a credit card applied to a credit card inquiry apparatus, comprising the steps of:
a) recognizing a credit inquiry data signal by reading the credit card of a user and transmitting the recognized credit inquiry data signal into a signal conversion means;
b) at the signal conversion means, receiving the credit inquiry data signal, modulating the credit inquiry data signal to generate a modulated credit inquiry data signal and transmitting the modulated credit inquiry data signal to a master modem of a CATV broadcasting station through the CATV network;
c) at the master modem of a CATV broadcasting station, demodulating the modulated credit inquiry data signal and transmitting the credit inquiry data signal whose protocol is changed to a VAN company; and
d) at the VAN company, receiving the protocol-changed credit card inquiry data and requesting credit card inquiry to the credit card company of the customer by using the data of the received credit inquiry data signal.

17. The method as recited in claim 16, further comprising the step of:
e) if the credit inquiry data signal received by the signal conversion means is a telephone call, transmitting the credit inquiry data signal to the VAN company through the telephone line.

18. The method as recited in claim 16 or 17, further comprising the steps of:
f) at the VAN company, receiving the credit inquiry data signal on the user's credit card from the credit card company, transmitting the credit inquiry result signal to the master modem of the cable TV broadcasting station;
g) at the master modem of the cable TV broadcasting station, modulating the credit inquiry result signal to generate a modulated credit inquiry result signal and transmitting it to the signal conversion means of the card affiliated store through the CATV network; and
h) recognizing the modulated credit inquiry result signal transmitted through the signal conversion means and outputting the recognized credit inquiry result.

19. The method as recited in claim 18, wherein the credit inquiry data signal of the step a) includes credit card information, affiliated store information and transaction information.

20. The method as recited in claim 18, wherein the protocol-changed credit inquiry data signal of the step c) is transmitted from the master modem of the cable TV broadcasting station to the VAN company through the dedicated line.

21. The method as recited in claim 18, wherein the protocol change in step c) is carried out for the interface with the MUX of the VAN company.

22. The method as recited in claim 18, wherein the credit inquiry result signal in step f) is transmitted from the VAN company to the master modem of the cable TV broadcasting station through the dedicated line.

23. A computer readable recording medium storing instructions for executing a method for inquiring a credit card applied to a credit card inquiry apparatus, the method comprising the steps of:
a) recognizing a credit inquiry data signal by reading the credit card of a user and transmitting the recognized credit inquiry data signal into a signal conversion means;
b) at the signal conversion means, receiving the credit inquiry data signal, modulating the credit inquiry data signal to generate a modulated credit inquiry data signal and transmitting the modulated credit inquiry data signal to a master modem of a CATV broadcasting station through the CATV network;
c) at the master modem of a CATV broadcasting station, demodulating the modulated credit inquiry data signal and transmitting the credit inquiry data signal whose protocol is changed to a VAN company; and
d) at the VAN company, receiving the protocol-changed credit card inquiry data and requesting credit card inquiry to the credit card company of the customer by using the data of the received credit inquiry data signal.

24. The computer readable recording medium as recited in claim 23, the method further including the step of:
e) if the credit inquiry data signal received by the signal conversion means is a telephone call, transmitting the credit inquiry data signal to the VAN company through the telephone line.

25. The computer readable recording medium as recited in claim 23 or 24, the method further including the step of:
f) at the VAN company, receiving the credit inquiry data signal on the user's credit card from the credit card company, transmitting the credit inquiry result signal to the master modem of the cable TV broadcasting station;
g) at the master modem of the cable TV broadcasting station, modulating the credit inquiry result signal to generate a modulated credit inquiry result signal and transmitting it to the signal conversion means of the card affiliated store through the CATV network; and
h) recognizing the modulated credit inquiry result signal transmitted through the signal conversion means and outputting the recognized credit inquiry result.
